(19) United States
(12) Patent Application Publication
(10) Pub. No.: US 2006/0139781 A1
(43) Pub. Date: Jun. 29, 2006

(54) Two component mirror and method of assembly

(76) Inventors: Bernd Waldmann, Nurtingen (DE); Stefan Dieter, Tubingen (DE)

Correspondence Address: Warn Hoffmann;Miller & LaLone, PO Box 70098, Rochester Hills, MI, 48307, US

(21) Appl. No.: 10/523,274

(22) PCT Filed: Jul. 25, 2003
(86) PCT No.: PCT/DE03/02503

§ 371 Date: Aug. 22, 2005

(30) Foreign Application Priority Data
Aug. 1, 2002 (DE) 102 35 100.7

(51) Int. Cl. G02B 7/182

(52) U.S. Cl. 359/872

(57) ABSTRACT

In inside or outside rearview mirrors of motor vehicles, the mirror housing (2) and the frame (4) constitute two parts, whereby the frame (4) is held on the mirror housing (3) by means of clips. In order to produce the component (2, 4) in a simple and economical manner, the two components are joined to each other by laser welding with their faces flush and contiguous. During the process, a laser beam is directed onto the contiguous edges and along the corresponding part such that the edges are welded together. The laser beam can also be directed by a third part, which reflects the laser beam to the flush, contiguous edges of the two other parts (2, 4), along which it is moved. The component (2, 4) and the method are preferably used to manufacture inside or outside rearview mirrors of motor vehicles.

The invention relates to a component consisting of at least two parts, preferably a mirror for vehicles, especially motor vehicles, according to the preamble of claim 1, and a method for manufacturing such a component according to the preamble of claim 12 or 14.

Components in the form of inside or outside rearview mirrors for motor vehicles are known in which the two parts are the mirror housing and the frame. The frame is held on the mirror housing by means of clips, for which purpose clips are injection molded on the frame. For assembly, the glass mirror with the frame must be clipped into the housing by hand. An additional disadvantage is that the frame must be made relatively wide, so it is visually obtrusive and also requires a relatively large amount of material for its fabrication. Hence, the mirror is time-consuming to assemble and expensive to manufacture.

The object of the invention is to design a component of the generic type and a method of the generic type such that it can be produced in a simple and economical manner.

This object is attained by the invention in a component of the generic type with the characterizing features of claim 1, and is attained by the invention in a process of the generic type with the characterizing features of claims 12 or 14.

The inventive component is characterized in that it can be produced economically and with sparing use of material. There is no need for a structurally complex design of the parts that constitute the component in order to permit laser welding. They are simply placed with their faces flush against one another. Reliable laser welding is possible as a result, so the two parts are welded firmly together.

In the inventive method according to claim 12, the laser beam is directed through the one part directly onto the abutting surfaces.

The inventive method according to claim 14 is used when the two parts to be welded together are not made of laser-absorbing material. Then the laser beam is directed through the third part, which reflects the laser beam to the abutting surfaces such that the two parts weld to one another at these abutting surfaces.

Additional features of the invention are apparent from the other claims, the description, and the drawing.

The invention is described in detail below on the basis of two example embodiments shown in the drawings. They show:

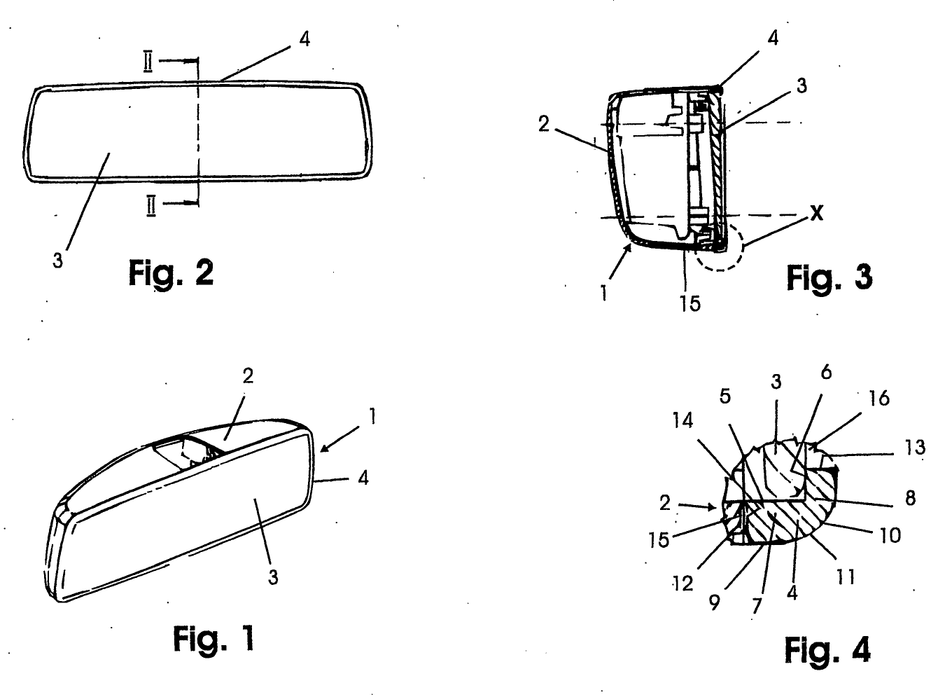

FIG. 1 a component according to the invention, designed as a rearview mirror for motor vehicles, in perspective view,

FIG. 2 the rearview mirror from FIG. 1 in front view,

FIG. 3 a cross-section along line III-III in FIG. 2,

FIG. 4 the detail X from FIG. 3 in an enlarged view,

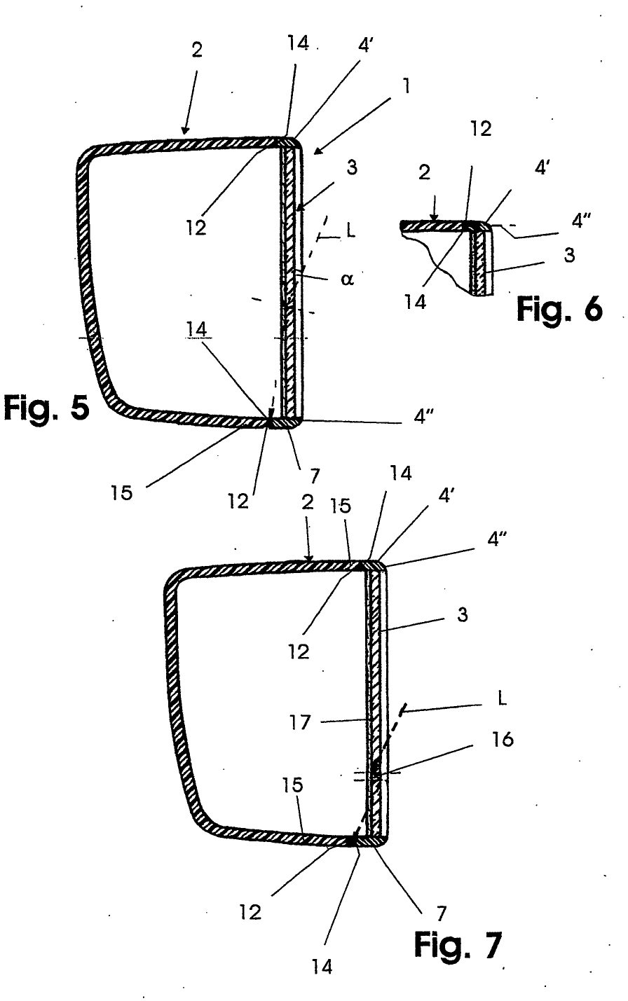

FIG. 5 a second embodiment of a mirror according to the invention in a cross-section corresponding to FIG. 3 and in an enlarged view with a laser beam,

FIG. 6 an enlarged view of a corner region of the mirror from FIG. 5,

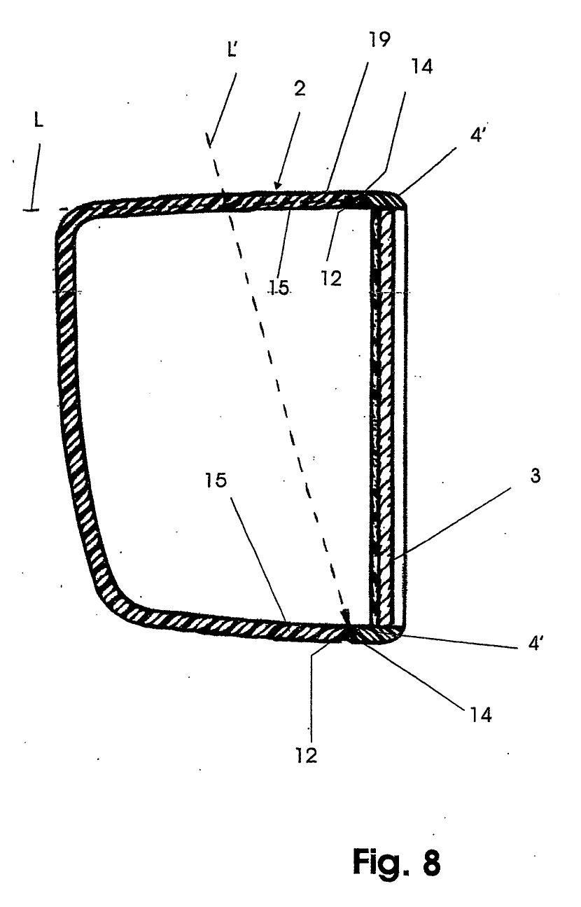

FIGS. 7 and 8 the mirror from FIG. 5, with a different laser beam path in each case.

The mirror 1 shown in the drawings is an inside rearview mirror of a motor vehicle. It has a mirror housing 2 in the opening of which a mirror glass 3 with a surrounding frame 4 is attached by laser welding. The mirror housing 2, at least in a region adjacent to the frame 4, is made of a laser-absorbing, weldable thermoplastic, which is pigmented with carbon, for example. Another pigmented material or laser-absorbing material may also be used, however. It is useful for the entire mirror housing 2 to be made of this material. The frame 4 is made of a laser-permeable, weldable thermoplastic. The mirror 1 is otherwise embodied in a known manner.

As is shown especially well in FIG. 4, the frame 4 has an L-shaped cross-section. The inner sides 5 and 6 of the frame sides 7 and 8 are flat in design and are perpendicular to one another. The outer sides 9 and 10 of the frame sides 7, 8 merge into one another through a rounded corner region 11. The shorter side 8 is slightly thinner than the longer side 7. Both sides 7 and 8 have flat faces 12 and 13. The face 12 of the longer side 7 lies flush against the free face 14 of the edge 15 of the mirror housing 2. The mirror glass 3 is overlapped on the outside by the side 8 of the frame 4, while the outer surface 16 of the mirror glass rests against the inner side 6 of said side 8.

The face 12 of the frame side 7 can of course also be partially beveled or, for example, can extend at an acute angle along its entire length. In this case the face 14 of the housing edge 15 is also correspondingly beveled so that the two surfaces 12, 14 again lie flush against one another.

As FIGS. 5 through 8 show, the frame 4′ can also consist of simply a continuous, straight web, whose outer corner region 4″ is rounded off in an arc. The frame 4′ has a flat face 12, which rests against the flat face 14 of the housing edge 15. The faces 12, 14 can be square or angled in similar fashion to the previous embodiment. In addition, the faces 12, 14 can be flat or curved, or can have another suitable shape; this holds for the previous example embodiment as well.

The frame 4, 4′ can further be designed such that it overlaps or is overlapped by the housing edge 15. In this case, the surfaces of the housing edge 15 and frame 4, 4′ to be welded together lie one atop the other. The surfaces can be welded together reliably by means of the laser beam L.

In order to join the frame 4, 4′ to the mirror housing 2, a laser source (not shown) is provided, which can consist of fiber-coupled laser diodes or Nd:YAG lasers, for example, which have a wavelength of 808, 940 or 1,064 nm in a power range of 20 to 1,000 watts, for example. For the laser welding process, first the housing 2 is placed in a template (not shown) and fixed in its position therein. The template projects beyond the side of the mirror housing 2 that has the housing opening for the mirror glass 3. Then, the frame 4 is placed on the edge 15 of the housing 2 from above, and secured against vertical shifting with a retaining plate (not shown). The retainer also keeps the frame 4, 4′ from shifting sideways or horizontally. Next, the laser device is used to direct the emerging laser beam along the frame 4, 4′ such that the laser beam strikes the faces 12 and 14 of the frame 4 and the housing edge 15 that are touching one another. At the face 14 of the mirror housing 2 made of laser-absorbing material, the thermoplastic materials of the frame 4, 4′ and the housing edge 15 are caused to melt. As a result of the contact pressure of the frame 4, 4′ acting on the housing 2, the frame is welded flawlessly to the housing. In the embodiment of the frame 4 described in FIGS. 1 to 4, in which the frame side 8 extends parallel to the mirror glass 3, the laser device is advantageously directed such that the emerging laser beam is perpendicular to the contiguous faces 12 and 14. In the case of the frame 4′ from FIGS. 5 through 7 as well, the emerging laser beam L can be perpendicular to the faces 12, 14, in which case it either strikes the frame 4′ from the front (FIG. 6) or strikes the housing 2 from the rear (FIG. 8).

As a result of the laser welding described, the design of the frame 4, 4′ can be relatively slim, since a secure joint between the frame 4, 4′ and the housing 2 is ensured by the laser welding, and there is no need for retaining parts fastened to the frame. As a result of the slim design, the frame 4, 4′ can be manufactured with a small amount of material and thus can be light in weight. Since the frame 4, 4′ is slim and the weld seam is smooth, the mirror frame 4, 4′ can also be made transparent using a glass-clear material. This transmission laser welding ensures that the mirror assembly will proceed flawlessly. Moreover, the welded joint between the frame 4, 4′ and the mirror housing 2 is not temperature sensitive, so the mirror 1 has a long lifetime even under adverse conditions.

The mirror housing in the example embodiment is a wedge mirror, but can also be any other suitable mirror glass. The side 7 of the frame 4 or the frame 4′ advantageously has the same thickness as the edge 15 of the mirror housing 2. The laser welding permits a flawless bond at the butt joint.

If the frame 4, 4′ of the mirror 1 is made of a material that is impermeable to laser beams, the laser device must be directed when welding the frame 4, 4′ to the housing 2 such that the laser beam L travels through the mirror glass 3 to the contiguous faces 12, 14 of the frame 4′ and the housing edge 15, as shown in FIGS. 5 and 7, for example. The laser beam L can travel through the mirror glass 3 directly to the faces 12, 14 (FIG. 5). In this case, the laser beam L is directed at the outer surface of the mirror glass at a very small acute angle α so that it passes through the mirror glass 3 and strikes the faces 12, 14. However, it is also possible to direct the laser beam L onto the outer surface of the mirror glass (FIG. 7) such that it is reflected at the rear surface 17 of the mirror glass 3 to its front surface 16, and from there to the faces 12, 14. Flawless welding of the contiguous faces 12, 14 of the frame 4 and housing 2 takes place in these cases as well.

As FIG. 8 further shows, the laser beam L can also be directed at an angle from the rear side 18 of the housing 2 through one wall, which in the example embodiment is the upper housing wall 19, preferably perpendicularly onto the contiguous faces 12, 14 of the housing edge 15 and the frame 4′ in order to weld them together. It is also possible to direct the laser beam L′ from the housing wall 19 at an angle through the housing 2 onto the contiguous faces 12 and 14 of the housing 2 and the frame 4′.

The laser welding described is suitable not only for the manufacture of motor vehicle rearview mirrors, but also for joining plastic components, for example diverging lenses, to a housing of a roof module. Moreover, it is also possible to perform welding in this way on the motor vehicle's sunglass storage compartment or on the base of an outside rearview mirror, or also on the turn signal lens or the lens of a perimeter light. The stability of components joined in this way can be significantly improved, since the sandwich-like joint achieves high strength in similar fashion to sheet-metal work without requiring the components to be correspondingly massive in design.

1. Component consisting of at least two parts, preferably a mirror for vehicles, especially motor vehicles, the two parts of which are firmly joined together, at least in sections, along their edges characterized in that the two parts (2, 4; 4′) are joined by laser welding with the faces (12, 14) of their edges (7, 15) flush against one another.

2. Component according to claim 1, characterized in that the one part (2) is made of a laser-absorbing, weldable material.

3. Component according to claim 2, characterized in that the one part (2) is made of thermoplastic material, preferably pigmented with carbon.

4. Component according to one of claims 1-3, characterized in that the other part (4; 4′) is made of a laser-permeable, weldable material.

5. Component according to claim 4, characterized in that the other part (4; 4′) is made of thermoplastic material.

6. Component according to one of claims 1-5, characterized in that the faces (12, 14) of the two parts (2, 4; 4′) are flat.

7. Component according to one of claims 1-6, characterized in that the two parts (2, 4; 4′) have the same thickness at their contiguous edges (7, 15).

8. Component according to one of claims 1-7, characterized in that the other part (4; 4′) has a web-like and/or approximately L-shaped cross-section.

9. Component according to claim 8, characterized in that the other, web-like part (4′) is rounded off in an arc at its outer edge (4″).

10. Component according to claim 8, characterized in that the two sides (7, 8) of the other, approximately L-shaped part (4) have different lengths.

11. Component according to claim 10, characterized in that the face (14) of the other part (4; 4′) and/or the face (12) of its longer side (7) makes area contact with the edge (15) of the one part (2).

12. Method for producing the component according to one of claims 1-11, in which the two parts are placed contiguous to one another at their edges, characterized in that a laser beam (L) is directed through the one part (2, 4; 4′) onto the contiguous, flush edges (12, 14) and is moved along this part (2, 4; 4′) such that the contiguous edges (7, 15) are welded together.

13. Method according to claim 12, characterized in that the light beam (L) is moved from a rear side (18) of the one part (2) to the contiguous edges (7, 15).

14. Method for producing the component according to one of claims 1-11, in which the two parts are placed contiguous to one another at their edges, characterized in that a laser beam (L) is directed through a third part (3), which reflects the laser beam (L) onto the contiguous, flush edges (7, 15) of the two other parts (2, 4; 4′), and in that the laser beam (L) is moved along the one part (2, 4; 4′) such that the contiguous edges (7, 15) weld together.

15. Method according to claim 14, characterized in that the laser beam (L) is moved through the third part (3) such that it is reflected from the rear surface (17) thereof to the front surface (18) of the third part (3), and is reflected from there to the contiguous edges (7, 15).
